(19) United States
(12) Patent Application Publication
(10) Pub. No.: US 2014/0370848 A1
(43) Pub. Date: Dec. 18, 2014

(54) SYSTEMS AND METHODS FOR EXCHANGING DATA RELATED TO UNCONSUMED CELLULAR TIME

(71) Applicant: Robert J. Petcavich, The Woodlands, TX (US)

(72) Inventor: Robert J. Petcavich, The Woodlands, TX (US)

(21) Appl. No.: 13/919,084

(22) Filed: Jun. 17, 2013

(51) Int. Cl. H04M 15/00; H04W 4/24

(52) U.S. Cl. CPC H04M 15/783; H04W 4/24
USPC 455/406

(57) ABSTRACT

A data exchange system for facilitating the purchase of cellular or wireless phone minutes and/or blocks of cellular time is provided. Potential cellular time and data buyers and sellers may access the exchange system via the internet and submit offers and or pricing requests to such a system. In response to the request, a server retrieves stored data from the seller's database, and allows for the potential buyer to view the cellular data or minutes for sale. The buyer and the seller exchange the related data and the minutes. The exchange system executes the transfer of the cellular minute and the data, via financial transactions between the buyers and the sellers, and then updates corresponding accounts of the buyers and sellers in conjunction with an appropriate cellular service network provider.

### FIELD OF THE DISCLOSURE

The present disclosure generally relates to a cellular phone minutes or data purchase system accessible via a communications network, and in particular relates to a data exchange system via the internet that facilitates buying and selling of subscriber minutes, blocks of cellular time, or related data.

### BACKGROUND

In an attempt to allocate wireless or cellular phone time efficiently, current cellular phone providers offer rollover minutes to their customers. In most cases, the minutes are not used in the current billing period and rolled over or added to the customers account for future use. As a result, there are many users with excess minutes that may not ever be used, which they have already paid for. Conversely, there are users that could use extra minutes but are not willing to pay the extra monthly subscription costs when there is a deficit in their monthly subscriber accounts. In addition, there are some geographic regions of the world that actually use mobile cellular minutes as a form of currency.

Accordingly, it would be desirable and advantageous to both the service provider and customer to have a system or method to sell or allocate any surplus minutes and in particular unused or unconsumed minutes to their entire customer base. By doing so, the cellular customers can reduce their costs on a monthly basis and the service providers can facilitate more efficient use of their network time, and balance the network call time loads efficiently. Conventionally, a challenge has been how the unconsumed minutes are located or provided using a method for all the users that want to buy and sell the minutes by finding each other in a cost effective way. There are over a billion cell phones used in the world and matching buyers and sellers would be cost prohibited without some efficient way to reduce transaction costs.

One aspect of the present invention is to provide an electronic market place where cellular phone users can buy or sell cellular phone minutes in a cost effective manner. Another aspect of this invention is to enable potential buyers and sellers to easily execute a financial transaction and exchange excess air time or minutes. Still another aspect of this invention is to provide an exchange system which enables a potential purchaser to easily and quickly review all options, and pricing information and execute the transaction within minutes. Another aspect of this invention is to provide a marketplace for cellular phone time to exchange for goods and services as a form of currency. Yet another aspect of this invention is that once a transaction is consummated between the seller and buyer the minute exchange information is automatically updated in the service provider databases for billing and tracking and exchange purposes.

### SUMMARY

These advantages are achieved by a cellular phone minute and data exchange system which includes, a file server having a plurality of databases storing specific information relating to users specific accounts and an amount of unconsumed minutes or data available for sale. The exchange system further includes a processor coupled to databases and programmed to perform tasks and show information such as minutes or data available, pricing, offers to sell, offers to buy, acceptance of the sellers terms and conditions, processing the financial transactions between buyers and sellers, and the updating the cellular service provider billing systems.

Specifically, the exchange system is coupled to a communications network, such as telephone lines, cellular networks, or the internet. A potential cellular minute buyer or seller may access the exchange system from a web site via the internet and submit a request to the exchange. In response to one or multiple requests, a system processor, such as a computer processor, or an administrator retrieves the stored data from the appropriate databases, and transmits the information to the party of interest and a buy sell transaction is executed and financial exchange completed.

The exchange system described above enables a very large network of cellular phone users to efficiently and cost effectively buy and sell excess air or data time in a very efficient manner. In addition, such an exchange allows for the cellular service providers to efficiently allocate network bandwidth to their customer subscriber base and also allows for the exchange of mobile minute time or data for goods and services in other words digital currency.

The foregoing and other aspects and features of the disclosure will become apparent to those of reasonable skill in the art from the following detailed description, as considered in conjunction with the accompanying drawings.

### BRIEF DESCRIPTION OF THE DRAWINGS

FIG. 1 illustrates an environment of the present data exchange system featuring a file server in accordance with an embodiment of the present disclosure; and

FIG. 2 is a flow chart of an exemplary data exchange method in accordance with an embodiment of the present disclosure.

### DETAILED DESCRIPTION

Preferred embodiments of the present disclosure are described below by way of example only, with reference to the accompanying drawings. Further, the following description is merely exemplary in nature and is in no way intended to limit the disclosure, its application, or uses. As used herein, the term “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality. Thus, while this disclosure includes particular examples and arrangements of the modules, the scope of the present system should not be so limited since other modifications will become apparent to the skilled practitioner.

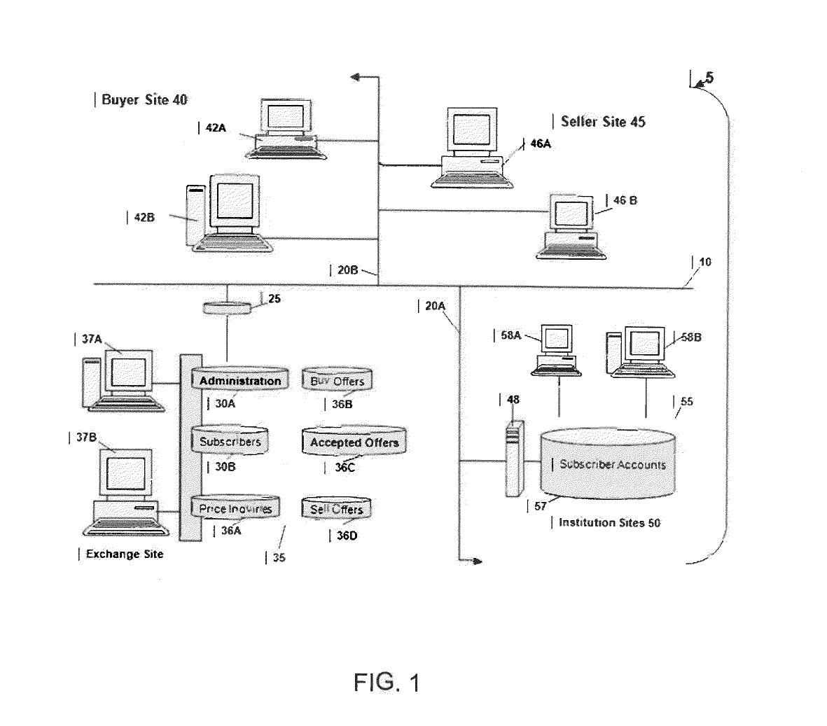

FIG. 1 illustrates an exemplary system architecture for a cellular phone minute and data exchange system 5 is shown. Included in the system 5 is a communications network 10 having multiple branches 20 A-B. The network 10 may be a wide area network such as the Internet or it may be a local area network or many other types of networks. Accordingly, although one embodiment of the present invention is described below in the context of the internet, it should be understood that the present invention may be used with many other types of communication or computer networks.

One embodiment of an exchange system 5 is illustrated in FIG. 1 as being coupled to a network 10 via a multi-line communications control and router 25. The system 5 includes, for example, a file or web server having a processor and memory storage. Such file servers are commercially available, for example, from IBM, Sun Microsystems, Hewlett Packard, and Dell computers. Databases 30 A-B and 35 are illustrated as forming part of the system 5. Databases 30 A-B can be part of the memory storage on the file server 35.

Administration database 30 A is utilized for storing data related to tasks executed by the system 5. The subscriber database 30 B stores data relating to all the personal information for buyers and sellers using the system, via the network 10, from remote sites. Database file server 35 further includes a price inquiries database 36 A, and offer to buy data base 36 B, and accepted offers database 36 C and Offer to sell price database 36 D. A plurality of personal computers 37A-B is coupled to the databases 35 via a local area network (LAN) to enable access and administration functions during operation. An exemplary database that can be used in the present invention is MySQL.

Buyer sites 40 and seller sites 45 are shown as being coupled to branch 20 B of network 10. Potential minute buyers through personal computers 42A-B, personal digital assistants or even cellular phones may access the network exchange system 5 through modems, wireless systems or routers 25. Similarly, sellers of minutes through the same devices 46A-B as above may access the network exchange system 5. The functions performed by the system 5 are different but the goal is to facilitate an efficient and cost effective transfer of cellular phone minutes or data between interested parties. It is also contemplated that the buyers and sellers include business entities that can purchase one or more blocks of cellular time (or phone minutes) in a wholesale price and trade the minutes on the present exchange system 5. Although a minute time period is described for illustrative purposes, any fractional unit of time period is contemplated in measuring the unconsumed cellular phone time.

Institution sites 50 are shown as being coupled to branch 20 A of network 10. Such institutions may include cellular service providers such as Verizon, AT&T, T-Mobile and many others. Institution sites 50 may access the exchange system 5 through a modem, the internet, wireless network, or router 48 coupled to a file server 55 having a cellular user subscriber accounts database 57, and via personal computers 58 A and 58 B. Account information for minute exchanges between buyers and sellers at the buyer and seller sites 40 and 45 using the exchange system 5 are updated and recorded in the institutional subscriber accounts database 57 for subsequent billing and tracking purposes.

It should be understood of course, that the architecture illustrated in FIG. 1 may vary depending on the type of network utilized. The entire system can be executed as a LAMP stack, which is short for a LINUX, Apache, MySQL, and Perl/PHP system that runs most of the internet sites today. Also additional buyer sites 40, and seller sites 45 and institutional sites 50 may be coupled to the exchange system 5. Further, a geographic area such as the world can be divided into regions with separate systems 5 that can respond to regional needs and cultural behaviors suitable for their specific geographic region or time zone.

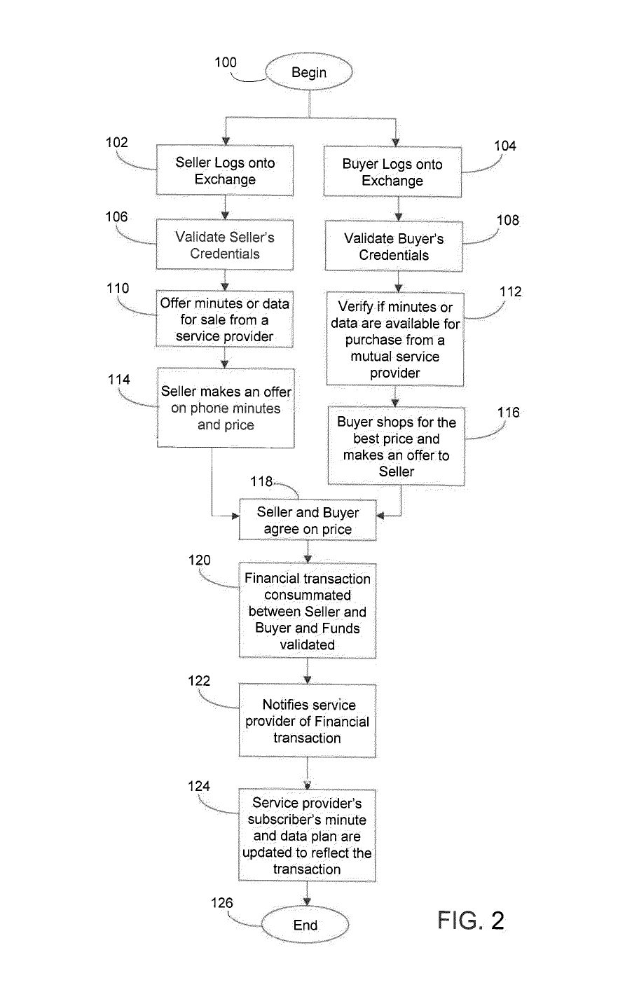

FIG. 2 shows an exemplary method for facilitating an allocation of unconsumed phone minutes and/or blocks of cellular time between a seller who offers to sell the minutes or time and a buyer who offers to purchase the minutes or time. Although the following steps are primarily described with respect to the embodiments of FIG. 1, it should be understood that the steps within the method may be modified and executed in a different order or sequence without altering the principles of the present disclosure.

The method begins at step 100. In step 102, the seller logs onto the present exchange system 5, using a computing device 42A-B, such as a smart phone, a personal computer, a tablet or other devices known in the art. In step 104, the buyer similarly logs onto the present exchange system 5 using the computing device 46A-B. In step 106, the system 5 validates credentials of the seller. In step 108, the system 5 validates credentials of the buyer. In step 110, the seller offers the unconsumed phone minutes, blocks of cellular time, or related data for sale from the associated institution site 50, such as a cellular phone service provider. In step 112, the buyer verifies whether the minutes or the data are available for purchase from the service provider 50. In the preferred embodiment, the service provider 50 is a mutual or same service provider for both the seller and the buyer. It is also contemplated that the service providers of the seller and the buyer are different.

In step 114, the seller makes an offer including a number of unconsumed phone minutes and/or blocks of cellular time, and a corresponding price for the buyers. In step 116, the buyer shops around for the best price for the minutes or time, and makes an offer for purchase to the seller. In step 118, the seller and the buyer negotiate and agree on the price. In step 120, a financial transaction between the seller and the buyer is consummated or settled based on the agreement, and funds associated with the financial transaction are validated from a seller's financial institution and a buyer's financial institution.

In step 122, the system 5 notifies the service provider 50 of the consummated financial transaction. In step 124, the service provider 50 respectively updates the seller's and buyer's minutes and associated data plans to reflect the consummated financial transaction. The method ends at step 126.

While preferred embodiments of the disclosure have been herein illustrated and described, it is to be appreciated that certain changes, rearrangements and modifications may be made therein without departing from the scope of the disclosure as defined by the appended claims.

1. A data exchange system for facilitating an allocation of unconsumed phone minutes or blocks of cellular time between a seller who offers to sell the minutes or time and a buyer who offers to purchase the minutes or time, comprising:
a file server having at least one database for storing data related to the unconsumed phone minutes or blocks of cellular time associated with a sale offer or a purchase offer;
a computer processor coupled to the file server and programmed to perform purchase and sale transactions of the minutes or time between the seller and the buyer;
means for communicating to the data exchange system for digitally communicating the purchase and sale transactions in response to the purchase and sale offers; and
a central processing module coupled to the file server, the processor, and the communication means for selectively settling the purchase and sale transactions based on the purchase and sale offers, and for transmitting instructions to an associated institution site such that the allocation of the unconsumed phone minutes or blocks of cellular time is respectively recorded in a seller's account and a buyer's account, both accounts residing in the institution site, based on the settled transactions.

2. The data exchange system of claim 1, wherein the communication means include a computer network having a plurality of branches connected to the buyer, the seller, the file server, and the associated institution.

3. The data exchange system of claim 2, wherein the associated institution site is coupled to the branch and accesses the file server through a carrier signal transmission device for exchanging the data related to the unconsumed phone minutes or time.

4. The data exchange system of claim 1, further comprising at least one multi-line communication control router connected to the file server for directing traffic of the data related to the unconsumed phone minutes or time between the buyer, the seller, the file server, and the associated institution.

5. The data exchange system of claim 1, wherein the database includes an administration database for storing data related to the purchase and sale transactions.

6. The data exchange system of claim 1, wherein the database includes at least one of: a price inquiries database, an offer to buy database, an accepted offers database, and an offer to sell database.

7. The data exchange system of claim 1, wherein the central processing module validates funds from the seller and the buyer based on the settled transactions, and notifies the associated institution site of the settled transactions.

8. The data exchange system of claim 1, wherein the database includes a subscribers database for storing data related to personal information of the buyer and the seller, the data related to personal information received from remote sites via the communication means.

9. The data exchange system of claim 8, wherein the associated institution site has a subscriber accounts database for storing the seller's account and the buyer's account, both accounts being updated and recorded for subsequent billing and tracking purposes.

10. The data exchange system of claim 1, wherein the data exchange system is geographically divided into at least one region having a separate data exchange system based on a regional need or a cultural behavior, each data exchange system configured for a specific geographic region or an associated time zone.

11. A computer-implemented method for facilitating an allocation of unconsumed phone minutes or blocks of cellular time between a seller who offers to sell the minutes or time, and a buyer who offers to purchase the minutes or time, comprising:
storing data related to the unconsumed phone minutes or blocks of cellular time associated with a sale offer or a purchase offer in a file server having at least one database;
performing purchase and sale transactions of the minutes or time between the seller and the buyer using a computer processor coupled to the file server;
communicating digitally the purchase and sale transactions in response to the purchase and sale offers;
settling selectively the purchase and sale transactions based on the purchase and sale offers;
transmitting instructions to an associated institution site such that the allocation of the unconsumed phone minutes or blocks of cellular time is respectively recorded in a seller's account and a buyer's account, both accounts residing in the institution site, based on the settled transactions.

12. The method of claim 11, further comprising:
logging onto a computer-implemented data exchange system by the seller and the buyer; and
validating credentials of the seller and the buyer.

13. The method of claim 11, further comprising receiving the data related to the unconsumed phone minutes or time for sale from the associated institution site.

14. The method of claim 11, further comprising verifying whether the unconsumed phone minutes, time, or the data related to the minutes are available for purchase from a mutual institution site of the seller and the buyer.

15. The method of claim 11, further comprising making the sale offer to the buyer, the sale offer including a number of unconsumed phone minutes or time, and a corresponding price.

16. The method of claim 11, further comprising:
shopping for a corresponding lowest price of the unconsumed phone minutes or time in the sale offer; and
making the purchase offer to the seller based on the lowest price.

17. The method of claim 11, further comprising making an agreement on a sale price for the unconsumed phone minutes or time between the seller and the buyer.

18. The method of claim 17, further comprising:
consummating a financial transaction between the seller and the buyer in response to the agreement; and
validating funds associated with the financial transaction from a seller's financial institution and a buyer's financial institution.

19. The method of claim 18, further comprising notifying the associated institution site of the consummated financial transaction.

20. The method of claim 18, further comprising updating respectively seller's and buyer's data plans based on the consummated financial transaction.
